(19) United States
(12) Patent Application Publication
(10) Pub. No.: US 2026/0310269 A1
(43) Pub. Date: Oct. 8, 2026

(54) EFFICIENT POWER SUPPLY ARCHITECTURE

(71) Applicant: MetaPWR Electronics Co., Ltd., Shanghai (CN)

(72) Inventors: Zhengyu YE, Shanghai (CN); Yahong Xiong, Shanghai (CN)

(73) Assignee: MetaPWR Electronics Co., Ltd., Shanghai (CN)

(21) Appl. No.: 19/636,939

(22) Filed: Apr. 2, 2026

(30) Foreign Application Priority Data
Apr. 3, 2025 (CN) 202510420046.7

(51) Int. Cl. G06F 1/18; G06F 1/20; G06F 13/40

(52) U.S. Cl. CPC G06F 1/189; G06F 1/20; G06F 13/4072

(57) ABSTRACT

An efficient power supply architecture includes a bus converter and a voltage regulation module, which are arranged on the same side of an XPU substrate, that is, on the side opposite to the XPU. By shortening a power transmission path between the voltage regulation module and the XPU and a power transmission path between the bus converter and the voltage regulation module, the loss along the transmission paths is reduced. On the other hand, by integrating passive components with the bus converter, or by arranging the voltage regulation module and the bus converter on an intermediate substrate, the assembly process of the system is simplified.

### CROSS-REFERENCE TO RELATED APPLICATION

This application claims the priority benefit of Chinese application serial no. 202510420046.7, filed on Apr. 3, 2025. The entirety of the above-mentioned patent application is hereby incorporated by reference herein and made a part of this specification.

### BACKGROUND

### Technical Field

The disclosure is related to an efficient power supply architecture.

### Description of Related Art

In recent years, with the development of technologies in fields such as data centers, artificial intelligence, and supercomputers, increasingly powerful ASICs have been widely applied, such as CPUs, GPUs, machine learning accelerators, network switches, and servers, which consume large currents, for example, up to thousands of amperes. In order to satisfy the requirement for fast response to load dynamics, the current industry practice is to adopt a two-stage converter, namely, a front-stage bus converter (for converting a 48V bus into a 12V bus or even lower) plus a post-stage voltage regulation module, so as to achieve voltage conversion from 48V to 1V. In addition, the post-stage voltage regulation module is arranged in vertical correspondence with an XPU, such that the power transmission path between the voltage regulation module and the XPU is the shortest, thereby, the parasitic impedance along the power transmission path and the loss along the power transmission path are reduced. However, due to space limitations and heat dissipation requirements, the bus converter is usually arranged on the same side of the smart card motherboard as the XPU, so that the power transmission path between the bus converter and the voltage regulation module is excessively long.

Therefore, how to develop the efficient power supply architecture to solve the problems faced by the prior art has become an urgent issue to be addressed in this field.

### SUMMARY

In view of the above, one of the objectives of the application is to provide an efficient power supply architecture, comprising an XPU, an XPU substrate, a smart card motherboard, a voltage regulation module and a bus converter; the XPU is arranged on a top surface of the XPU substrate, a bottom surface of the XPU substrate is attached to, fixed to, and electrically connected with a top surface of the smart card motherboard; the bus converter and the voltage regulation module are arranged below the XPU; the voltage regulation module is arranged in vertical correspondence with the XPU; the bus converter is electrically connected to the voltage regulation module; the voltage regulation module is electrically connected to the XPU.

Preferably, the bus converter is arranged on a bottom surface of the smart card motherboard.

Preferably, the projections of bus converter and the XPU substrate on the bottom surface of the smart card motherboard at least partially overlap.

Preferably, the bus converter and the voltage regulation module adjoin each other, and the bus converter is electrically connected to the voltage regulation module through the smart card motherboard.

Preferably, the voltage regulation module is embedded in the smart card motherboard, a bottom surface of the voltage regulation module is located within the smart card motherboard, flushed with the bottom surface of the smart card motherboard, or protruded from the bottom surface of the smart card motherboard.

Preferably, the voltage regulation module and the XPU are directly electrically connected.

Preferably, the bus converter is arranged in vertical correspondence with the voltage regulation module, the bus converter and the voltage regulation module are directly electrically connected, or electrically connected through the smart card motherboard.

Preferably, the voltage regulation module is arranged between the XPU and the smart card motherboard, the bus converter and is arranged in vertical correspondence with the voltage regulation module.

Preferably, the voltage regulation module is arranged between the XPU and the XPU substrate, the voltage regulation module and the XPU are directly electrically connected.

Preferably, the voltage regulation module is arranged between the XPU substrate and the smart card motherboard, the voltage regulation module and the XPU are electrically connected through the XPU substrate, the bus converter and the voltage regulation module are electrically connected through the smart card motherboard.

Preferably, both the voltage regulation module and the bus converter include stepped portions, and two stepped portions are arranged in vertical correspondence.

Preferably, the two stepped portions are attached and/or electrically connected.

Preferably, t the efficient power supply architecture also includes a front-side heat dissipation device and a back-side heat dissipation device; the front-side heat dissipation is thermally connected with the XPU; the back-side heat dissipation device is thermally connected with the bus converter and/or the voltage regulation module.

Preferably, the voltage regulation module is thermally connected with the back-side heat dissipation device through a metal block.

Preferably, the efficient power supply architecture also includes an intermediate substrate, a top surface of the intermediate substrate is attached to, fixed to, and electrically connected with the bottom surface of the smart card motherboard; the voltage regulation module is arranged on a bottom surface of the intermediate substrate; the voltage regulation module is electrically connected with the XPU through the intermediate substrate, the smart card motherboard and the XPU substrate.

Preferably, the bus converter is arranged on the bottom surface of the intermediate substrate; the bus converter is electrically connected to the smart card motherboard through the intermediate substrate; the bus converter and the voltage regulation module are electrically connected through the intermediate substrate.

Preferably, the bus converter is a bus converter assembly, the voltage regulation module is a voltage regulation module assembly; the bus converter assembly and the voltage regulation module assembly adjoin each other and electrically connected through the intermediate substrate.

Preferably, a top surface of the bus converter is arranged a hollow groove, the hollow groove is used to accommodate passive components.

Preferably, the efficient power supply architecture also includes passive components, the passive components and the bus converter are integrated together; the passive components are arranged adjacent to a top surface of the bus converter, and the pins of the passive components are arranged on the top surface of the bus converter.

Preferably, the bus converter is arranged on the bottom surface of the smart card motherboard; the bus converter and the voltage regulation module are electrically connected through the smart card motherboard and the intermediate substrate.

Compared with the prior art, the application has the following beneficial effects.

The present application provides an efficient power supply architecture in which the bus converter and the voltage regulation module are arranged on the same side of the XPU substrate, that is, on the side opposite to the XPU. By shortening the power transmission path between the voltage regulation module and the XPU and the power transmission path between the bus converter and the voltage regulation module, the loss along the transmission paths is reduced;

On the other hand, by integrating passive components with the bus converter, or by arranging the voltage regulation module and the bus converter on an intermediate substrate, the assembly process of the system is simplified. To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a conventional power supply architecture;

FIGS. 2A-2E show an efficient power supply architecture;

FIG. 3 shows another efficient power supply architecture;

FIGS. 4A-4C show another efficient power supply architecture;

FIGS. 5A and 5B show an efficient power supply architecture adopting an ultra-thin voltage regulation module;

FIGS. 6A and 6B show a partial structure of an efficient power supply device.

### DESCRIPTION OF THE EMBODIMENTS

One of the cores of the present application is to provide an efficient power supply architecture.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

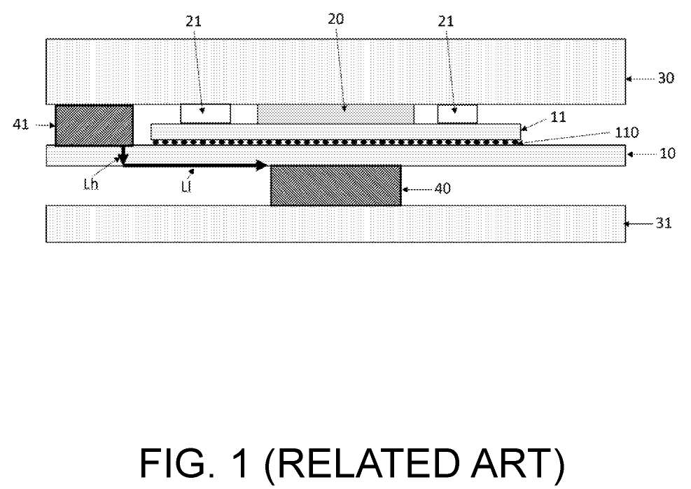

As shown in FIG. 1, the conventional structure of the power supply architecture is as follows. An XPU 20 is arranged on a top surface of an XPU substrate 11. A bottom surface of the XPU substrate 11 and a top surface of a smart card motherboard 10 are fixed and electrically connected through conductive connection portions 110, wherein the conductive connection portions are preferably solder balls. A bus converter 41 is arranged on the top surface of the smart card motherboard 10, that is, on the same side of the smart card motherboard 10 as the XPU, and cannot overlap the XPU substrate 11. A voltage regulation module 40 is arranged on a bottom surface of the smart card motherboard 10, and the voltage regulation module 40 is arranged in vertical correspondence with the XPU 20, that is, the projections of the voltage regulation module 40 and the XPU 20 on the top surface of the smart card motherboard at least partially overlap. In this power supply architecture, the bus converter 41 and the XPU 20 share a front-side heat dissipation device 30. A top surface of the voltage regulation module 40 is attached to, fixed to, and electrically connected with the bottom surface of the smart card motherboard 10, and a bottom surface of the voltage regulation module 40 is provided with a back-side heat dissipation device 31. The back-side heat dissipation device 31 is used to dissipate heat from the voltage regulation module 40. In this embodiment, the power transmission path L1 between the bus converter 41 and the voltage regulation module 40 is shown in FIG. 1 as Lh and Ll, wherein Lh is the thickness of the smart card motherboard 10, and Ll is the horizontal distance between the bus converter 41 and the voltage regulation module 40. Therefore, in the related art, the power transmission path L1 is relatively long, and the loss along the power transmission path L1 is relatively large.

### Embodiment 1

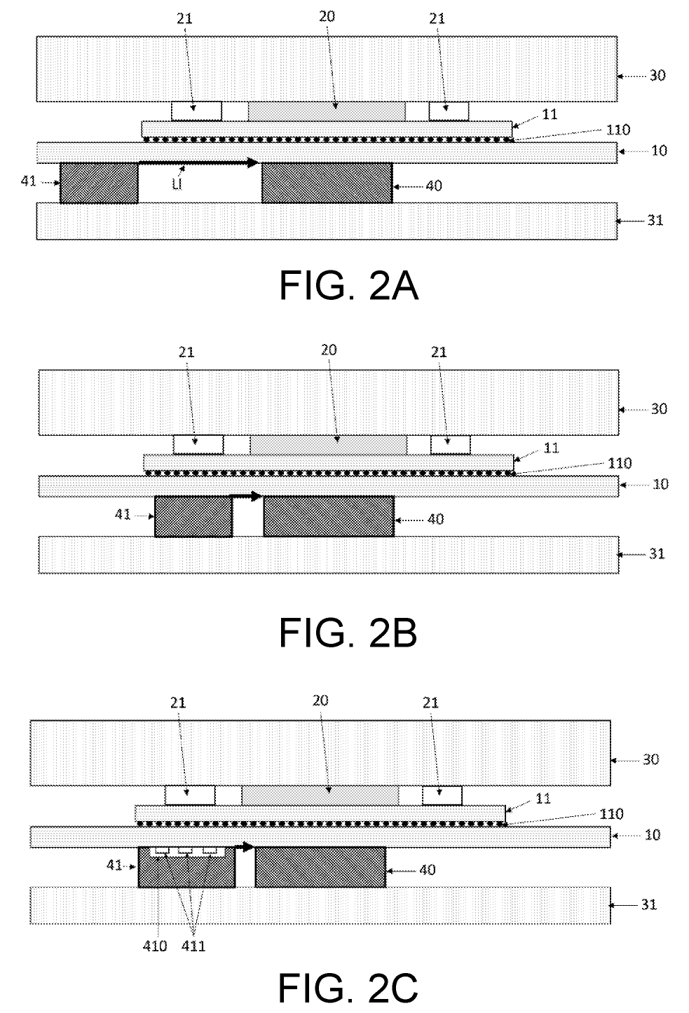

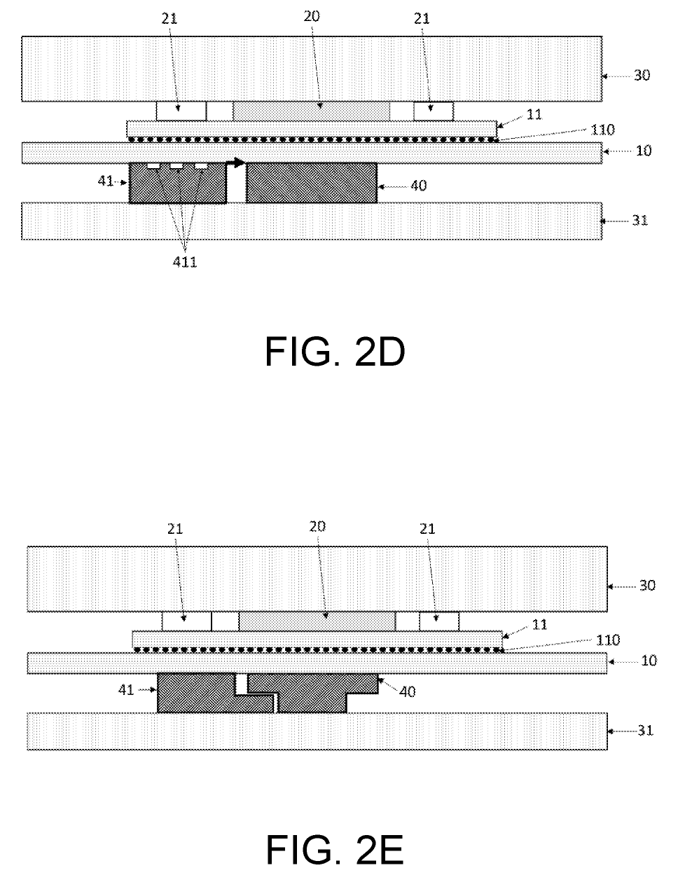

As shown in FIGS. 2A-2D, the bus converter 41 is moved from the top surface of the smart card motherboard 10 to the bottom surface, that is, it is arranged on the bottom surface of the smart card motherboard 10 together with the voltage regulation module 40. As shown in FIG. 2A, the bus converter 41 and the XPU substrate 11 do not overlap in a vertical direction, and do not occupy the space required for output capacitors around the voltage regulation module 40. Therefore, the power transmission path between the bus converter 41 and the voltage regulation module 40 is simply Ll. The power transmission path is shortened, thereby the loss along the transmission path is reduced. On the other hand, the bus converter 41 and the voltage regulation module 40 share the back-side heat dissipation device 31, which can reduce the heat dissipation pressure on the front-side heat dissipation device 30. FIG. 2B shows another implementation in which the bus converter 41 and the XPU substrate 11 at least partially overlap in the vertical direction, a part of the space for output capacitors around the voltage regulation module 40 is occupied, but the power transmission path between the bus converter 41 and the XPU 20 is further shortened. Furthermore, the bus converter 41 and the XPU 20 may be arranged to adjoint each other, so that the shortest power transmission path between them can be achieved.

The efficient power supply architecture further includes other chips 21. The other chips 21 are arranged on the top surface of the XPU substrate 11 and around the XPU 20, and these chips 21 are thermally connected with the front-side heat dissipation device 30.

FIG. 2C shows another implementation of Embodiment 1. Since the smart card motherboard 10 may include multiple Power Rails, each Power Rail requires multiple filter capacitors or other passive components to be arranged on the bottom surface of the smart card motherboard 10. In this implementation, a hollow groove 410 is formed on a top surface of the bus converter 41, and the hollow groove 410 is used to accommodate passive components 411, namely multiple filter capacitors or other passive components. The shape and depth of the hollow groove 410 may be set according to actual requirements and are not limited herein. In another implementation, as shown in FIG. 2D, the passive components 411 are integrated into the bus converter 41. The passive components 411 are arranged adjacent to the top surface of the bus converter 41, and the pins of the passive components 411 are exposed on the top surface of the bus converter. The power transmission path is shortened and the problem of installation space for the passive components is solved through this structure. On the other hand, the assembly process of the system is simplified and the operating reliability of the bus converter is improved.

FIG. 2E shows another efficient power supply architecture, wherein both the voltage regulation module 40 and the bus converter 41 are fixed to and electrically connected to the smart card motherboard 10, and the voltage regulation module 40 and the bus converter 41 are electrically connected through the smart card motherboard 10. Both the voltage regulation module 40 and the bus converter 41 are thermally connected with the back-side heat dissipation device 31. The voltage regulation module 40 is arranged in vertical correspondence with the XPU 20. Both the voltage regulation module 40 and the bus converter 41 include stepped portions, and the two stepped portions at least partially overlap vertically, an occupied area or space of the voltage regulation module and the bus converter can be reduced. The two stepped portions may also be attached and/or electrically connected, the power transmission path and a power transmission impedance between the bus converter and the voltage regulation module are further reduced.

### Embodiment 2

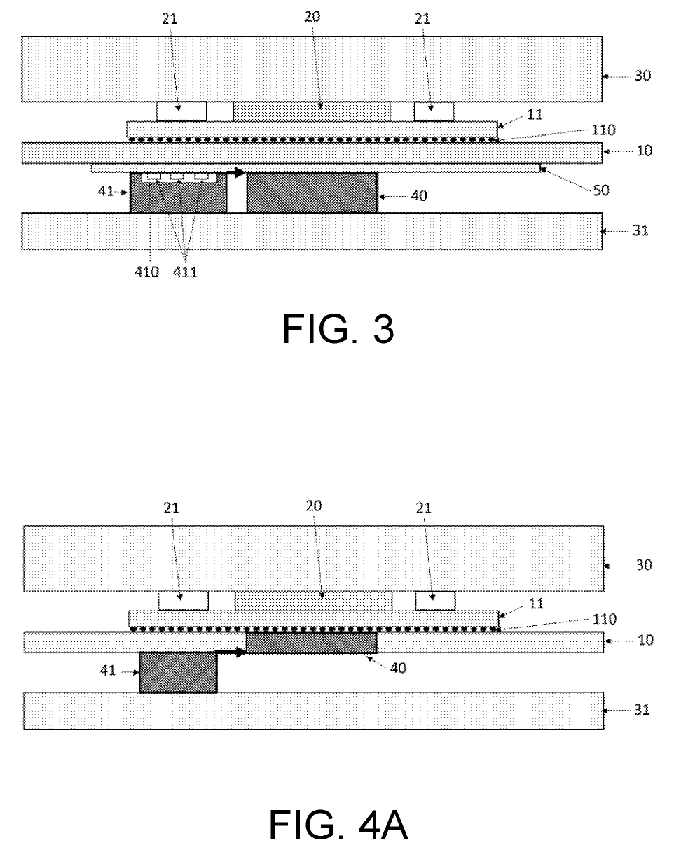

On the basis of all implementations shown in Embodiment 1, an intermediate substrate 50 is added. FIG. 3 is taken as an example for illustration. The bus converter 41 and the voltage regulation module 40 are arranged on a bottom surface of the intermediate substrate 50, such that the bus converter 41 and the voltage regulation module 40 are fixed through the intermediate substrate 50 and transmit power through the intermediate substrate 50, thereby reducing the power transmission impedance between the bus converter 41 and the voltage regulation module 40. A top surface of the intermediate substrate 50 is fixed to and electrically connected with the bottom surface of the smart card motherboard 10. The output power of the voltage regulation module 40 is transmitted to the XPU 20 via the intermediate substrate 50 and the smart card motherboard 10. In this implementation, the bus converter 41 and the voltage regulation module 40 may be pre-arranged on the intermediate substrate 50 and then assembled with the smart card motherboard 10 as a whole, thereby further simplifying the assembly process on the system. In other implementation, the voltage regulation module 40 is arranged on the bottom surface of the intermediate substrate 50, and the bus converter 41 is arranged on the bottom surface of the smart card motherboard 10; the bus converter 41 is electronically connected to the voltage regulation module 40 through the smart card motherboard 10 and the intermediate substrate 50.

### Embodiment 3

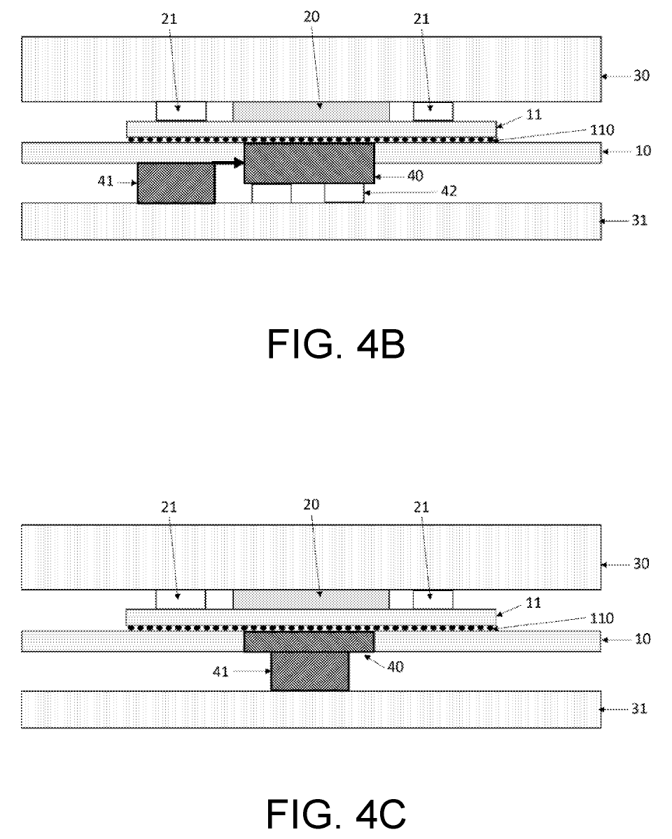

FIGS. 4A-4E show another efficient power supply architecture in which the voltage regulation module 40 is embedded in the smart card motherboard 10, so that the XPU substrate 11 is directly electrically connected with the voltage regulation module 40 through the conductive connection portions 110, a distance between the voltage regulation module 40 and the XPU 20 is further reduced. Specifically, as shown in FIG. 4A, the bottom surface of the voltage regulation module 40 is exposed from the bottom surface of the smart card motherboard 10. Optionally, the bottom surface of the voltage regulation module 40 is embedded in the smart card motherboard 10, flushed with the bottom surface of the smart card motherboard 10, or protruded from the bottom surface of the smart card motherboard 10. The bus converter 41 is arranged on the bottom surface of the smart card motherboard 10 and below the XPU substrate 11 in the vertical direction; however, the projections of the bus converter 41 and the voltage regulation module 40 on the bottom surface of the smart card motherboard do not overlap. Furthermore, a bottom surface of the bus converter 41 is thermally connected with the back-side heat dissipation device 31; the bottom surface of the voltage regulation module 40 may be attached to the back-side heat dissipation device through a metal block. As shown in FIG. 4B, the bottom surface of the voltage regulation module 40 is protruded from the bottom surface of the smart card motherboard 10, and the voltage regulation module 40 is thermally connected with the back-side heat dissipation device 31 through a plurality of metal pillars 42. In another implementation, as shown in FIG. 4C, the bottom surface of the voltage regulation module 40 is fixed to and thermally connected with the top surface of the bus converter 41. The bottom surface of the bus converter 41 is thermally connected with the back-side heat dissipation device 31. FIG. 4C is shown merely as an example and is not limited herein.

### Embodiment 4

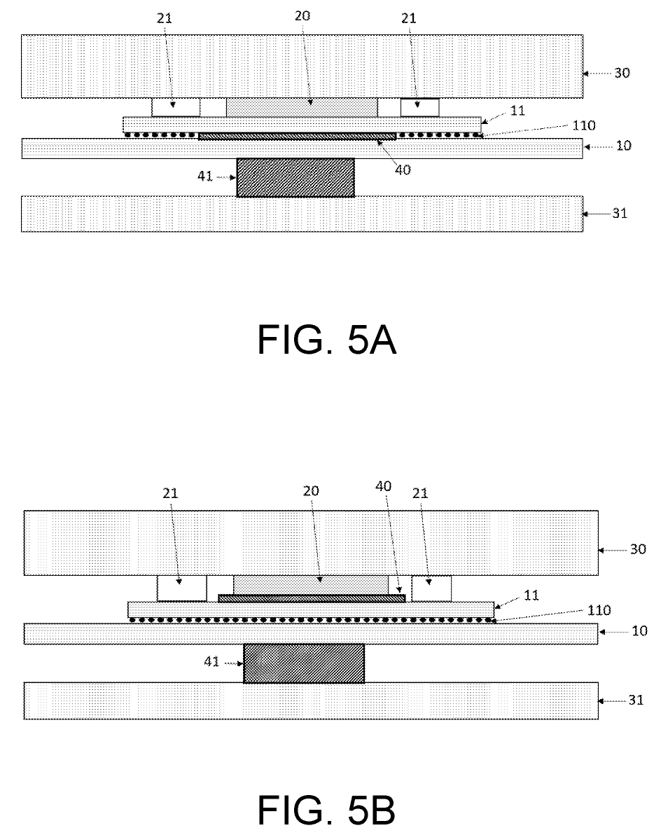

In this embodiment, an ultra-thin voltage regulation module 40 is adopted, as shown in FIG. 5A. The voltage regulation module 40 is arranged between the XPU substrate 11 and the smart card motherboard 10, and the voltage regulation module 40 is arranged in vertical correspondence with the XPU. The bus converter 41 is arranged on the bottom surface of the smart card motherboard 10, and is arranged in vertical correspondence with the voltage regulation module 40. The bottom surface of the bus converter 41 is thermally connected with the back-side heat dissipation device 31. Therefore, the shortest power transmission path between the voltage regulation module 40 and the XPU 20 can be obtained, and the shortest power transmission path between the bus converter 41 and the voltage regulation module 40 can also be obtained, thereby the power loss along the transmission path is further reduced and the dynamic performance requirements of the XPU 20 is satisfied.

FIG. 5B shows another implementation in which the voltage regulation module 40 is arranged between the XPU 20 and the XPU substrate 11, and the voltage regulation module 40 is directly electrically connected with the XPU 20, thereby the power transmission path between the voltage regulation module 40 and the XPU 20 is further shortened, the loss along the transmission path is reduced, and the dynamic performance is improved. The bus converter 41 is arranged on the bottom surface of the smart card motherboard 10 and is thermally connected with the back-side heat dissipation device 31. The bus converter 41 and the voltage regulation module 40 are arranged in vertical correspondence, such that the power transmission path between the bus converter 41 and the voltage regulation module 40 is the shortest.

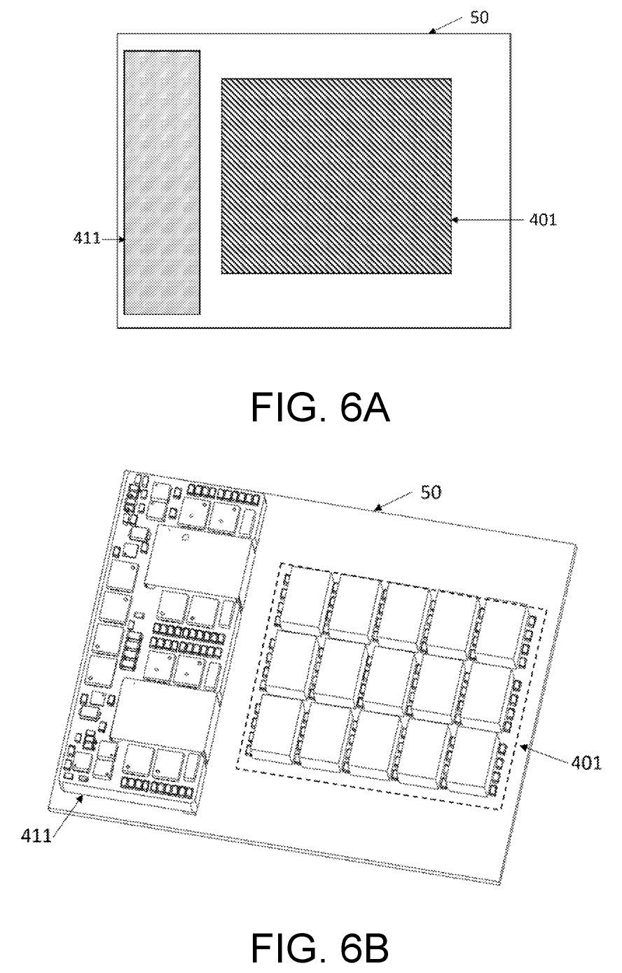

With respect to the efficient power supply architecture shown in Embodiment 2, the present application further discloses a partial structure of an efficient power supply device, as shown in FIGS. 6A and 6B. FIG. 6A shows a schematic top view of the efficient power supply device, and FIG. 6B shows a three-dimensional schematic of the efficient power supply device. A voltage regulation module assembly 401 and a bus converter assembly 411 are arranged to adjoin each other on the same side of the intermediate substrate 50, and the voltage regulation module assembly 401 and the bus converter assembly 411 are electrically connected through the intermediate substrate 50, thereby, the requirement of converting 54V to 0.8V is realized. The voltage regulation module assembly 401 includes a plurality of voltage regulation modules for converting an input voltage of 3.3V/1.8V into an output voltage of 0.8V. The bus converter assembly 411 may also include a plurality of bus converters for converting an input voltage of 54V into an output voltage of 3.3V/1.8V. A plurality of Ball Grid Array (BGA) arrays are arranged on the bottom surface of the intermediate substrate 50. The plurality of BGA arrays include an input positive terminal Vin+ of the bus converter 40, an output positive terminal Vo+ of the voltage regulation module 41, a ground terminal GND, a sampling signal terminal, a control signal terminal, and the like. The detailed BGA arrangement may be configured according to the principle of proximity and is not limited herein.

The efficient power supply architecture according to the embodiment can be a part of the electronic device, and can meet the technical features and advantages disclosed by the application.

The " equal " or " same " or " equal to " disclosed by the application needs to consider the parameter distribution of engineering, and the error distribution is within +/-30%; and the included angle between the two line segments or the two straight lines is less than or equal to 45 degrees; the included angle between the two line segments or the two straight lines is within the range of [ 60, 120 ]; and the definition of the phase error phase also needs to consider the parameter distribution of the engineering, and the error distribution of the phase error degree is within +/-30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An efficient power supply architecture, comprising:
an XPU,
an XPU substrate, the XPU being arranged on a top surface of the XPU substrate;
a smart card motherboard, a bottom surface of the XPU substrate being attached to, fixed to, and electrically connected with a top surface of the smart card motherboard;
a voltage regulation module, arranged in vertical correspondence with the XPU and electrically connected to the XPU; and
a bus converter, electrically connected to the voltage regulation module,
wherein the bus converter and the voltage regulation module are arranged below the XPU.

2. The efficient power supply architecture of claim 1, wherein the bus converter is arranged on a bottom surface of the smart card motherboard.

3. The efficient power supply architecture of claim 2, wherein the projections of the bus converter and the XPU substrate on the bottom surface of the smart card motherboard at least partially overlap.

4. The efficient power supply architecture of claim 3, wherein the bus converter and the voltage regulation module adjoin each other, and the bus converter is electrically connected to the voltage regulation module through the smart card motherboard.

5. The efficient power supply architecture of claim 2, wherein the voltage regulation module is embedded in the smart card motherboard, a bottom surface of the voltage regulation module is located within the smart card motherboard, flushed with the bottom surface of the smart card motherboard, or protruded from the bottom surface of the smart card motherboard.

6. The efficient power supply architecture of claim 5, wherein the voltage regulation module and the XPU are directly electrically connected.

7. The efficient power supply architecture of claim 5, wherein the bus converter is arranged in vertical correspondence with the voltage regulation module, the bus converter and the voltage regulation module are directly electrically connected, or electrically connected through the smart card motherboard.

8. The efficient power supply architecture of claim 2, wherein the voltage regulation module is arranged between the XPU, the smart card motherboard and the bus converter, and is arranged in vertical correspondence with the voltage regulation module.

9. The efficient power supply architecture of claim 8, wherein the voltage regulation module is arranged between the XPU substrate and the smart card motherboard, the voltage regulation module and the XPU are electrically connected through the XPU substrate, and the bus converter and the voltage regulation module are electrically connected through the smart card motherboard.

10. The efficient power supply architecture of claim 2, wherein the voltage regulation module is arranged between the XPU and the XPU substrate, and the voltage regulation module and the XPU are directly electrically connected.

11. The efficient power supply architecture of claim 2, wherein both the voltage regulation module and the bus converter include stepped portions, and two of the stepped portions are arranged in vertical correspondence.

12. The efficient power supply architecture of claim 11, wherein the two stepped portions arranged in vertical correspondence are attached and/or electrically connected.

13. The efficient power supply architecture of claim 1, wherein the efficient power supply architecture further includes a front-side heat dissipation device and a back-side heat dissipation device; the front-side heat dissipation is thermally connected with the XPU; the back-side heat dissipation device is thermally connected with the bus converter and/or the voltage regulation module.

14. The efficient power supply architecture of claim 13, wherein the voltage regulation module is thermally connected with the back-side heat dissipation device through a metal block.

15. The efficient power supply architecture of claim 1, wherein the efficient power supply architecture further includes an intermediate substrate, a top surface of the intermediate substrate is attached to, fixed to, and electrically connected with the bottom surface of the smart card motherboard; the voltage regulation module is arranged on a bottom surface of the intermediate substrate; the voltage regulation module is electrically connected with the XPU through the intermediate substrate, the smart card motherboard and the XPU substrate.

16. The efficient power supply architecture of claim 15, wherein the bus converter is arranged on the bottom surface of the intermediate substrate; the bus converter is electrically connected to the smart card motherboard through the intermediate substrate; the bus converter and the voltage regulation module are electrically connected through the intermediate substrate.

17. The efficient power supply architecture of claim 16, wherein the bus converter is a bus converter assembly, the voltage regulation module is a voltage regulation module assembly; the bus converter assembly and the voltage regulation module assembly adjoin each other and electrically connected through the intermediate substrate.

18. The efficient power supply architecture of claim 15, wherein the bus converter is arranged on the bottom surface of the smart card motherboard; the bus converter and the voltage regulation module are electrically connected through the smart card motherboard and the intermediate substrate.

19. The efficient power supply architecture of claim 1, wherein a top surface of the bus converter is arranged with a hollow groove, and the hollow groove is used to accommodate passive components.

20. The efficient power supply architecture of claim 1, wherein the efficient power supply architecture further includes passive components, the passive components and the bus converter are integrated together; the passive components are arranged adjacent to a top surface of the bus converter, and the pins of the passive components are arranged on the top surface of the bus converter.
